(19) United States
(12) Patent Application Publication
(10) Pub. No.: US 2019/0141381 A1
(43) Pub. Date: May 9, 2019

(54) DATA DELIVERY VIA A COMMUNICATIONS NETWORK

(71) Applicant: Telstra Corporation Limited, Melbourne (AU)

(72) Inventors: Gary Edison TRAVER, Melbourne (AU); Geoff FIELD, Melbourne (AU); Al-Mukaddim Khan PATHAN, Melbourne (AU); Stephen SPICER, Melbourne (AU)

(73) Assignee: Telstra Corporation Limited, Melbourne (AU)

(21) Appl. No.: 16/096,643

(22) PCT Filed: Feb. 22, 2017
(86) PCT No.: PCT/AU2017/050156

§ 371 Date: Oct. 25, 2018

(30) Foreign Application Priority Data
May 6, 2016 (AU) 2016901668

(51) Int. Cl. H04N 21/262; H04N 21/231; H04L 29/08; H04L 29/06

(52) U.S. Cl. CPC H04N 21/26241; H04N 21/26291; H04L 65/4084; H04L 67/2847; H04L 67/325; H04N 21/23106

(57) ABSTRACT

The present disclosure relates to the delivery of data or over a communications network. In a preferred form it relates to the delivery of data, such as media content, software or application updates and web content, to devices such as smartphones, tablets and notebook computers. In an embodiment, the system 100 includes one or more recipient devices (e.g. 102a, 102b, 102c) for receiving data and a data deliverer 104 communicatively coupled to the one or more recipient devices (e.g. 102a, 102b, 102c) via a communications network 106. The one or more recipient devices (e.g. 102a, 102b and 102c) and the data deliverer 104 may be located remotely from one another. In an embodiment, the data deliverer 104 is configured to perform a method 200 including steps 202, 204, 206 and 208. At step 202, the data deliverer 104 determines a schedule of data delivery. At step 204, the data deliverer 104 schedules in accordance with the schedule the one or more recipient devices to pre-position data to facilitate deferred consumption. At step 206, the data deliverer 104 obtains data from a data provider. At step 208, the data deliverer 104 delivers the obtained data to the one or more recipient devices to be pre-positioned to facilitate deferred consumption in the respective one or more recipient devices in accordance with the schedule.

### FIELD

The present disclosure relates to the delivery of data or over a communications network. In a preferred form it relates to the delivery of data, such as media content, software or application updates and web content, to devices such as smartphones, tablets and notebook computers.

### BACKGROUND

Network-connected electronic devices are capable of consuming data. For example, modern devices, such as smartphones, tablets, notebook computers, television sets, set-top boxes or the like, have the audio-visual capability to playback media content such as music videos, movies, sports footage, and television programmes. While communications networks are capable of delivery of data to devices for user consumption on demand, this delivery of data requires the network to allocate scarce network resources, the availability of which can fluctuate, for example over time and space, due to factors such as network traffic conditions and network coverage. For media content, this fluctuation in availability may manifest in a delayed or choppy playback, affecting user experience in consuming the media content. In a software or application update scenario or a website browsing scenario, loading delays can frustrate the user experience, prompting the user to abandon the update process or the website loading process before completion.

Reference to any prior art in the specification is not, and should not be taken as, an acknowledgment or any form of suggestion that this prior art forms part of the common general knowledge in any jurisdiction or that this prior art could reasonably be expected to be understood, regarded as relevant and/or combined with other pieces of prior art by a person skilled in the art.

### SUMMARY

According to a first aspect of the invention, there is provided a method of data delivery via a communications network, the method including the steps of:

(a) determining a schedule of data delivery,

(b) scheduling in accordance with the schedule one or more recipient devices to pre-position data to facilitate deferred consumption on the respective one or more recipient devices, and

(c) delivering in accordance with the schedule via the communications network the data to the one or more recipient devices to be pre-positioned to facilitate deferred consumption on the respective one or more recipient devices.

The delivering step may include broadcasting the data to the one or more recipient devices. The method may further include:

(i) causing the one or more recipient devices to determine whether the pre-positioned data is received by the one or more recipient devices; and

(ii) in the event of a determination of non-receipt of the pre-positioned content by a respective recipient device, causing the respective recipient device to obtain the data via unicast.

The determination of non-receipt may be based on expiry of a predetermined period.

The broadcasting step may include broadcasting via Long Term Evolution Broadcast (LTE-B).

The determining step may include determining the schedule based on traffic conditions of the communications network.

The determining step may include determining the schedule based on a geographical location of the one or more recipient devices.

The method may further include determining the data to obtain.

The scheduling step may include communicating the schedule of data delivery to the one or more recipient devices via a pre-positioning service on the respective one or more recipient devices, the pre-positioning service preparing the respective one or more recipient devices to receive and store the data in accordance with the schedule.

The pre-positioning service may be configured to receive and store the data for a plurality of applications on the respective one or more recipient devices.

The pre-positioned data may represent a first part of a data file, and the method may further include delivering a second part of the data file to the one or more recipient devices for immediate consumption on the respective one or more recipient devices.

The one or more recipient devices may include two or more recipient devices.

The method may further include obtaining the determined data to be pre-positioned from a data provider.

According to a second aspect of the invention, there is provided a data deliverer configured to perform the method of the first aspect.

According to a third aspect of the invention, there is provided a method of data consumption via a communications network, the method including the steps of, at one or more recipient devices:

(a) receiving a schedule of data delivery determined by a data deliverer;

(b) preparing the one or more recipient devices to pre-position data, to facilitate deferred consumption, in accordance with the schedule;

(c) receiving from the data deliverer via the communications network data delivered in accordance with the schedule; and

(d) pre-positioning the received data on the respective one or more recipient devices to facilitate deferred consumption on the respective one or more recipient devices.

The method may further include consuming the pre-positioned data on the respective one or more recipient devices.

The pre-positioned data may represent a first part of a data file, and wherein the method may further include receiving a second part of the data file to the one or more recipient devices for immediate or substantially immediate consumption on the respective one or more recipient devices.

The receiving step may include listening to a broadcast of the data to the devices.

The preparing may include waking up the devices and/or activating a service or background task of the devices in accordance with the schedule.

The method may further include:

(i) determining whether the pre-positioned data is received by a respective recipient device; and

(ii) in accordance with the determination of non-receipt of the pre-positioned content by the respective recipient device, obtaining the data via unicast.

The determination of non-receipt may be based on expiry of a predetermined period.

According to a fourth aspect of the invention, there is provided a method of enabling a recipient device to pre-position data to facilitate deferred consumption, the method including the step of:

providing a pre-positioning service for installation on the device, the pre-positioning service operatively coupled to one or more applications of the device configured to consume network data, and communicatively coupled to a communications network for pre-positioning data to facilitate deferred consumption by the respective one or more applications.

According to a fifth aspect of the invention, there is provided a recipient device configured to perform the method of the third aspect. The method of the third aspect may be performed by a pre-positioning service running on said recipient device.

According to a sixth aspect of the invention, there is provided a machine-readable medium for facilitating data delivery via a communications network from a data deliverer to a recipient device, the machine-readable medium including instructions for:

(a) communicating with one or more applications of the device configured to consume network data;

(b) communicating with the communications network for pre-positioning data for deferred consumption by the respective one or more applications;

(c) receiving pre-positioned data to facilitate deferred consumption by the respective one or more applications; and

(d) providing the pre-positioned data to the one or more applications for the deferred consumption.

According to a seventh aspect of the invention, there is provided a system for data delivery via a communications network, the system including:

(a) one or more recipient devices for receiving content;

(b) a data deliverer communicatively coupled to the one or more recipient devices via the communications network and configured to:
(i) determine a schedule of data delivery;
(ii) schedule one or more recipient devices to pre-position data to facilitate deferred consumption in accordance with the schedule;
(iii) deliver the data to the one or more recipient devices to be pre-positioned, to facilitate deferred consumption in the respective one or more recipient devices, in accordance with the schedule.

According to an eighth aspect of the invention, there is provided a method of consuming data on a recipient device that is connected to a communications network, wherein said consumption of data is performed via an application resident on said device, said method including:
providing a pre-positioning service for installation on the device, the pre-positioning service operatively coupled to the application,
the pre-positioning service:
   receiving a network request from the application for the delivery of data from a media source connected to the communications network;
   determining if the network request relates to data that is pre-positioned in local cache associated with the pre-positioning service; and
   in the event that the requested data is pre-positioned in the local cache, providing at least a portion of the data from the local cache instead of the media source.

### BRIEF DESCRIPTION OF THE DRAWINGS

Further aspects of the present disclosure and further embodiments of the aspects described in the preceding paragraphs will become apparent from the following description, given by way of example and with reference to the accompanying drawings.

FIG. 1 illustrates schematically an embodiment of a system of the present disclosure.

FIG. 2 illustrates a flowchart representing an embodiment of a method implemented by a data deliverer of the present disclosure.

FIG. 3 illustrates a flowchart representing an embodiment of a method implemented by a recipient device of the present disclosure.

FIG. 4 is a block diagram illustrating components of an exemplary system in accordance with an embodiment.

FIG. 5 is a flowchart illustrating the operation of the system of FIG. 4 in pre-positioning content on a recipient device.

### DETAILED DESCRIPTION OF EMBODIMENTS

In this specification: “Pre-positioning” in the context of data delivery to a device refers to placing, storing, or otherwise arranging data on the device in advance of consuming the data.
“Consumption” in the context of data refers to playback, display, installation, rendering or otherwise use of the data by a device. Consumption of data may be initiated in any manner, e.g. initiated automatically by an operating system, application or other software/firmware etc. running on the recipient device, or initiated by a user through interaction with the recipient device. Thus, as will be appreciated, the consumption of data may be perceivable to a user or may not.

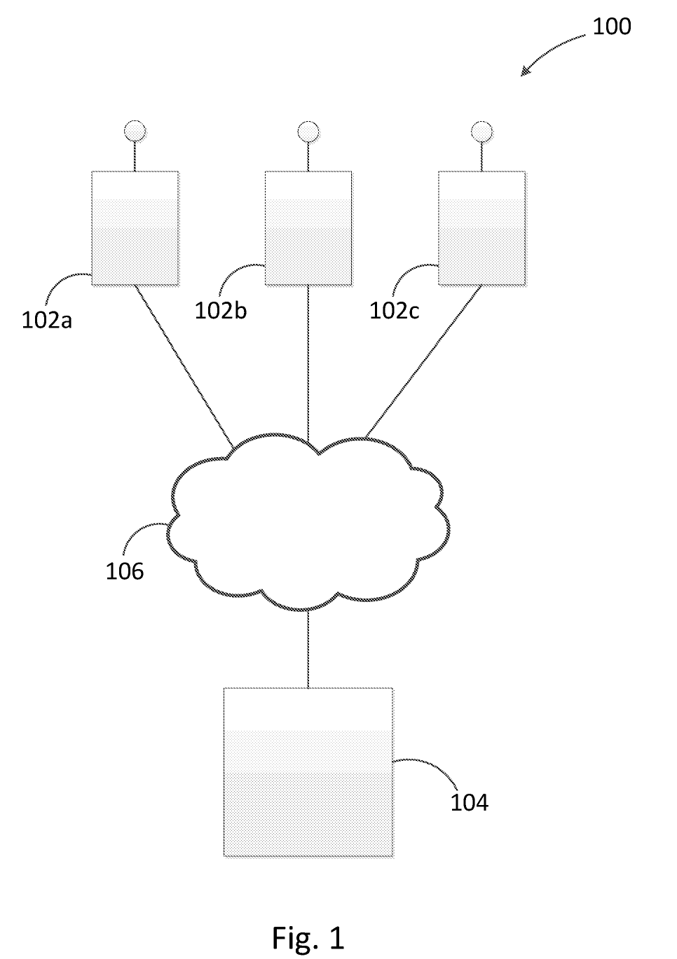

Described herein is a system and related methods of data delivery via a communications network. In an embodiment, as shown in FIG. 1, the system 100 includes one or more recipient devices (e.g. 102a, 102b, 102c) for receiving data and a data deliverer 104 communicatively coupled to the one or more recipient devices (e.g. 102a, 102b, 102c) via a communications network 106. The one or more recipient devices (e.g. 102a, 102b and 102c) and the data deliverer 104 may be located remotely from one another.

“Data” in the context of data delivery refers to data in digital form which is consumable by an electronic device. For example, the data may be media content, software or application updates, and web content. As media content, the data may include video data, audio data, or their combination. As software or application updates, the data may be machine-executable files such as applications (apps). As web content, the data may include rich media website objects. In some cases, the data may include a combination of the above types of data. For example, a video clip may be embedded in a website as part of the web content, in which case the data is a combination of media content and web content. Where the description hereinafter refers to a type of data (e.g. media content) in exemplary embodiments, such description is, mutatis mutandis, equally applicable to other types of data.

The one or more recipient devices (e.g. 102a, 102b and 102c) may separately be one of the following electronic devices: a laptop, a mobile phone, a tablet, a television set, and a set top box or the like. The one or more recipient devices include necessary hardware (e.g. a processing unit, memory, display, speaker, and/or audio jack) and software (e.g. codecs) to consume data. The data deliverer 104 may include a computer system having a processing unit and a machine-readable medium, such as a memory, storing instructions which, when executed by the processing unit, performs a method 200 (see below). In each of the recipient devices (e.g. 102a, 102b and 102c) and the data deliverer 104, through a communications bus, the processing unit is in data communication with respective memory, which can be a read-only memory (e.g. storing a BIOS for basic system operations), a volatile memory (e.g. random access memory such as one or more DRAM modules), and a non-transient memory (e.g. one or more hard disk drives, solid state drives, flash memory devices and suchlike). The one or more recipient devices (e.g. 102a, 102b and 102c) and the data deliverer 104 may each store one or more applications in their respective memory. Further, the processing unit in each one or more recipient devices (e.g. 102a, 102b and 102c) and the data deliverer 104 may run one or more such applications through the respective communications bus. Such applications will typically include at least an operating system such as Microsoft Windows, Apple OSX, Unix, Linux, Apple iOS, Google Android, or other operating system. For the one or more recipient devices (e.g. 102a, 102b and 102c), such applications may further include one or more of the following: a video and/or audio player for consuming media content, a web browser for consuming web content, a software or application updater for consuming software or application updates.

The one or more recipient devices (e.g. 102a, 102b and 102c) and the data deliverer 104 are each network-connected to facilitate the data delivery. For example, each have a network interface configured to communicatively couple to the communications network 106. For example, the communications network 106 may include one or more of a mobile network (e.g. a fourth-generation network, such as a Long Term Evolution (LTE) network), a wireless network (e.g. a Wi-Fi network) and a wired network (e.g. ADSL network). The network interface may correspondingly include a mobile communication interface, a wireless communication interface and a wired communication interface. The communications protocol employed by the one or more recipient devices and the data deliverer may include any suitable communications protocols, such as the Transmission Control Protocol (TCP) and/or the Internet Protocol (IP).

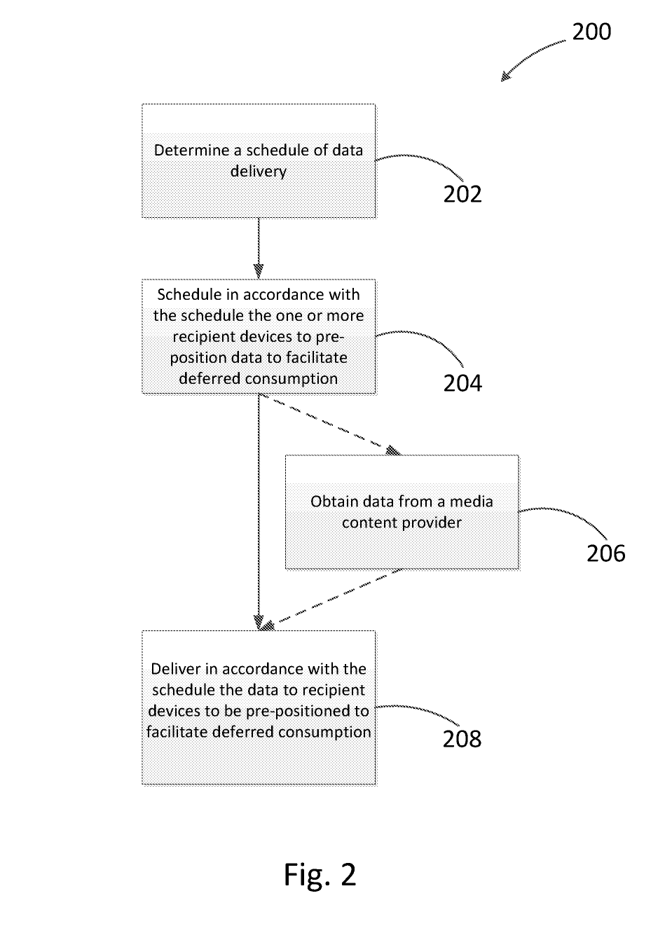

As shown in FIG. 2, the data deliverer 104 is configured to perform a method 200 including steps 202, 204, 206 and 208. At step 202, the data deliverer 104 determines a schedule of data delivery. At step 204, the data deliverer 104 schedules in accordance with the schedule the one or more recipient devices to pre-position data to facilitate deferred consumption. At step 206, which is optional, the data deliverer 104 obtains data from a data provider. At step 208, the data deliverer 104 delivers the obtained data to the one or more recipient devices to be pre-positioned to facilitate deferred consumption in the respective one or more recipient devices in accordance with the schedule.

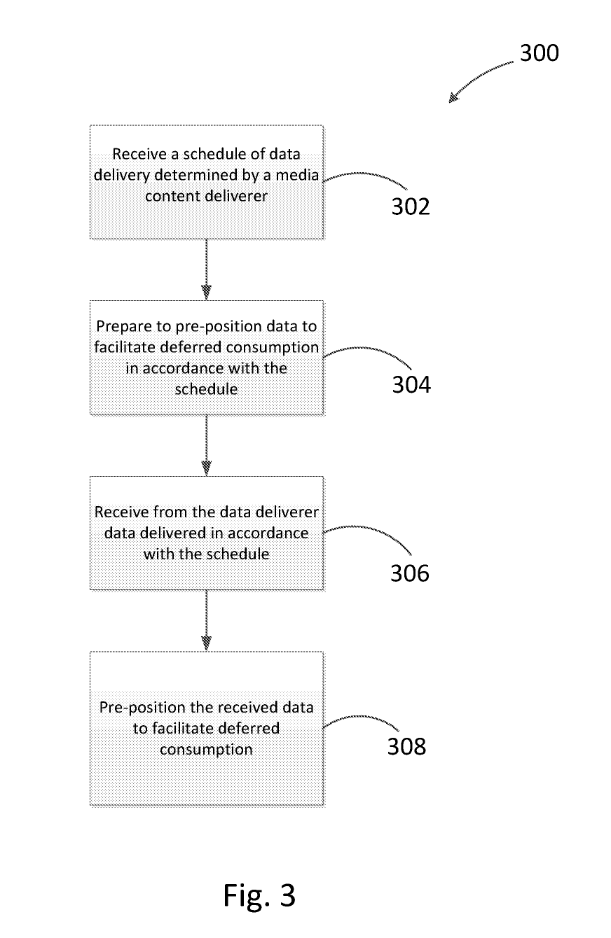

As shown in FIG. 3, the one or more recipient devices are configured to perform a method 300, including steps 302, 304, 306 and 308. At step 302 (corresponding to steps 202 and 204), the one or more recipient devices receive a schedule of data delivery determined by a data deliverer. At step 304 (corresponding to step 204), the one or more recipient devices are prepared to pre-position data to facilitate deferred consumption in accordance with the schedule. At step 306 (corresponding to step 208), the one or more recipient devices receive from the data deliverer via the communications network data, for example obtained by the data deliverer from a data provider, that is delivered in accordance with the schedule. At step 308 (also corresponding to step 208), the one or more recipient devices pre-position the received data on the respective one or more recipient devices to facilitate deferred consumption on the respective one or more recipient devices.

Since steps 302 to 308 of method 300 have corresponding steps in method 200, the following description on the steps of method 200 is therefore, with minor modifications, applicable to steps 302 to 308. The steps 302 to 308 may be performed by a pre-positioning service running on each respective recipient device. In a first form, the pre-positioning service is accessible to a plurality of applications on each recipient device. In a second form, the pre-positioning service is built into individual applications on each recipient device. To enable a recipient device to pre-position data to facilitate deferred consumption, a pre-positioning service may be provided by, for example the data deliverer, for installation on the device. In the first form, the pre-positioning service is operatively coupled to one or more applications of the device configured to consume network data, and communicatively coupled to a communications network for pre-positioning data for deferred consumption by the respective one or more applications. In the second form, as mentioned above, the pre-positioning service is built into individual applications.

At step 202, the determination may be based on one or more factors. For example, a determining factor is network traffic conditions of the communications network 106. As network traffic can be cyclical (e.g. typically having decreased network usage before 6 am and after business hours), network traffic conditions can be predicted to some extent. The schedule may therefore be determined based on such prediction. The schedule may include a single period (or start time) or multiple periods (or start times). For example, the schedule may be 3 am in the morning, where network traffic is expected to be low. As another example, the schedule may involve regular intervals, such as every hour between 9 am to 5 pm for no more than 5 minutes, so that network traffic will not be further congested by the pre-positioning in an already congested period.

As another example, a determining factor is a geographical location of the one or more recipient devices. If it is determined (such as by cellular triangulation, A-GPS or other means of geolocation) that a high number of recipient devices are located at or near a certain area (such as at or near a sports stadium hosting a sports event), the schedule for these geographically located devices may be determined to be during a recess period of the sports event, where demand for replays or highlights of the sports game is high, or determined to be as soon as possible so that these recipient devices are able to receive the broadcast before their users leave the certain area.

At step 204, deferred consumption generally refers to consumption some time after the data has been pre-positioned. Consumption may follow a notification to the user that data is available for consumption. Alternatively, it may be some period (minutes, hours, or days) after the data is pre-positioned, for example, when the user decides to consume the data. In one embodiment, the scheduling includes communicating the schedule of data delivery to the one or more recipient devices via a pre-positioning service on the respective one or more recipient devices. In this embodiment, the pre-positioning service prepares the respective one or more recipient devices to receive and store the data in accordance with the schedule.

Delivery preparation may include waking up the respective one or more recipient devices and/or activating any required but idle service or background task shortly before the data delivery is scheduled to commence. Alternatively or additionally, delivery preparation may include checking, such as causing the recipient device to determine, whether the respective one or more recipient devices includes sufficient storage space for storing the data to be pre-positioned. The threshold for determining sufficient storage space may be specified by the user of the recipient device, for example, via a graphical user interface of the pre-positioning service. For example, the user may specify any one or more of following: how much of the device storage space is allocated for pre-positioning, what maximum file size is allowed to be pre-positioned and stored, and how many pieces of data (e.g. pieces of media content) are allowed to be pre-positioned and stored. Additionally or alternatively, the user may specify that data is to be pre-positioned only when the battery capacity is above a certain level (e.g. 40%). If any one or more of these delivery preparation steps fail, the recipient device is configured to omit steps 306 and 308. The failed delivery preparation steps(s) may be re-checked, for example regularly until the delivery is scheduled to commence and until the failed delivery preparation steps(s) pass without fail. In one scenario where any one or more of the delivery preparation steps of a recipient device (e.g. 102a) fail, the pre-positioning service may be configured to notify the data deliverer 104 about the failure, so that the recipient device need not expect or determine receipt (see more below) of the pre-positioned data. In another scenario where any one or more of the delivery preparation steps of a recipient device (e.g. 102a) fail, the pre-positioning service may be configured to display a notification on the recipient device (e.g. 102a) about the failure. The displayed notification may prompt the user to take corrective steps (e.g. allowing device to wake up or providing more storage space by deletion of files) to allow the delivery preparation to proceed. In this scenario, the pre-positioning service may regularly re-check successful delivery preparation until the delivery schedule commences.

At step 206, the data provider may be a computer system at a remote third-party provider (such as a TV network broadcaster, an online video content provider server, or an entity having the broadcasting rights of certain content, mirror web site for storing software and/or application updates, and/or a web server for providing web content). The data provider may include a local storage to store the data retrievable via the communications network 106 by the data deliverer 104 upon request. The obtaining may include determining the data to obtain. In one embodiment, the data deliverer 104 may be configured to analyse previous content consumption by the one or more recipient devices, based on which certain data may be obtained from the data provider for subsequent pre-positioning. For example, the data deliverer 104 may determine that a group of recipient devices has consumed the most recent two episodes of a certain TV drama. Based on this previous consumption, the data deliverer 104 may be configured to obtain the next episode of the same TV drama from the TV broadcaster and schedule the group of recipient devices to pre-position this next episode to facilitate deferred consumption. In some embodiments, the data deliverer 104 includes the data provider.

At step 208, the delivering step may include broadcasting the obtained data to the one or more recipient devices (where the recipient devices are configured to listen to the broadcast). For example, if the delivery employs a Long Term Evolution (LTE) cellular networking standard, the broadcasting may be achieved via LTE-Broadcast (LTE-B) to deliver the identical data to a group of recipient devices for pre-positioning (which may be a subset of the one or more recipient devices) at the same or substantially the same time. An advantage of a broadcast as compared to, for example, unicasting or multicasting to a limited number of recipient devices is a more efficient use of network resources by removing the need to distribute identical data in multiple separate sessions. Nonetheless, in one embodiment, the one or more recipient devices are configured to fall back to unicasting if the broadcasting does not eventuate or does not reach the recipient devices. For example, the receiving at step 306 includes determining whether the pre-positioned data is received by the one or more recipient devices, and, in accordance with the determination of non-receipt of the pre-positioned data by one or more of the one or more recipient devices, obtaining the data via unicast from the data deliverer 104.

To facilitate use of unicast as fall back, the scheduling at step 204 includes providing unicast instructions to the one or more recipient devices to cause the recipient devices to initiate a data transfer via unicast (i.e. to “pull” the data to be pre-positioned) in case of non-receipt of the data. The non-receipt of the pre-positioned data by a recipient device may be determined based on expiry of a predetermined period. For example, the unicast instructions may include instructions to determine the non-receipt of the data if the data to be pre-positioned is not received within a timeout period (e.g. 30 minutes) starting from the commencement of the scheduled delivery.

In one configuration, the pre-positioning service of a recipient device is configured to receive and store (e.g. locally at a memory of recipient device) data for a plurality of applications on the recipient device. While the plurality of applications are each allowed to consume network data, the pre-positioning service is configured to facilitate consumption of data in one or both of two ways:
First, where the pre-positioning service determines receipt of the pre-positioned data, the pre-positioning service may be configured to notify the respective application of the local availability of the data. In one case, the application may display a notification on the recipient device so that the user is aware of its local availability. In another case, the application may not display a notification on the recipient device.
Second, where the user requests the application for consumption of certain data, the pre-positioning service may receive a request from the application for checking whether the certain data has been pre-positioned. If the pre-positioning service determines that the requested data has been pre-positioned, the pre-positioning service provides the pre-positioned data to the application for consumption. If the pre-positioning service determines that the requested data has not been pre-positioned, the pre-positioning service may notify the application of the unavailability, or may retrieve the requested data for the application. Here, the pre-positioning service may act as a proxy service to the application installed in the device.

In one scenario, the pre-positioned data represents a first part of a data file having a subsequent second part that has not been pre-positioned. For example, the data deliverer 104 may be configured to pre-position only the first 5 minutes of the next episode of the certain TV drama for deferred consumption, with the remaining 45 minutes not pre-positioned. In one example, while the first part (e.g. the first 5 minutes) is being consumed, the pre-positioning service requests and receives the second part (e.g. the next 5 minutes, or the 45 minutes) for immediate consumption on the respective recipient device. Alternatively, in another example, while the first part (e.g. the first 5 minutes) is being consumed, the recipient device obtains the data via the communications network without or bypassing the pre-positioning service.

The data deliverer 104 includes appropriate means for performing each step of the method 200. For example, the data deliverer 104 may include the means, such as a processing unit, for determining a schedule of data delivery at step 202. Further, the data deliverer 104 may include the means, such as a pre-positioning controller module communicatively coupled to the pre-positioning service, for scheduling in accordance with the schedule the one or more recipient devices to pre-position data to facilitate deferred consumption at step 204. Further still, the data deliverer 104 may include means, such as a data module communicatively coupled to the data provider, for obtaining data from the data provider at step 206. Yet further still, the data deliverer 104 may include means, such as a content delivery module communicatively coupled to a content delivery network (e.g. a LTE broadcast system), for delivering the obtained data to the one or more recipient devices to be pre-positioned to facilitate deferred consumption in the respective one or more recipient devices in accordance with the schedule at step 208.

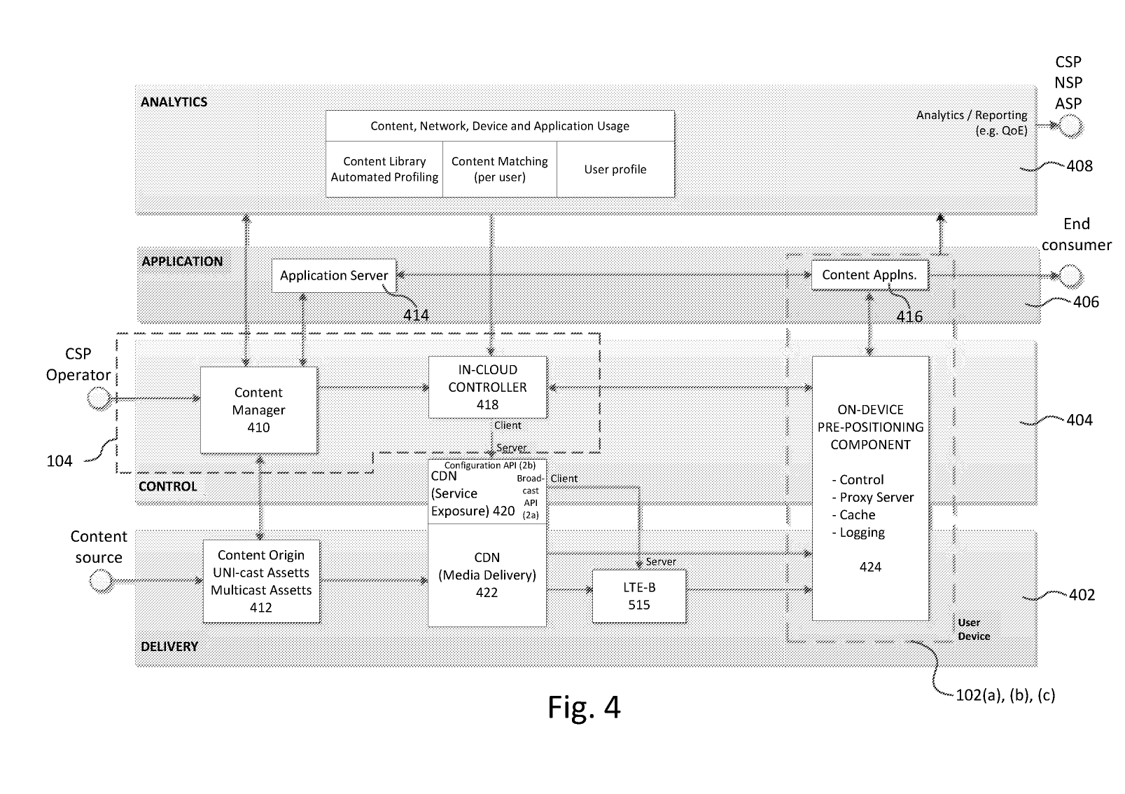

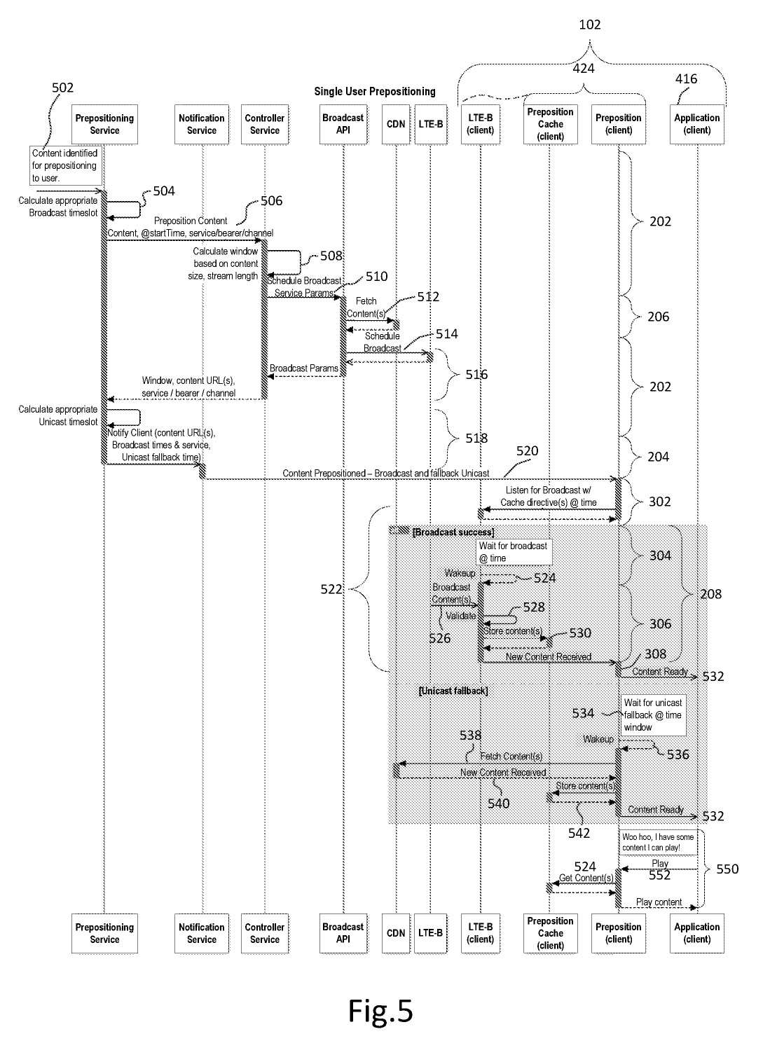

Further details of an embodiment of the present invention will now be described in more detail in connection with FIGS. 4 and 5. To aid understanding, pre-positioning of data on only a single recipient device will be described, but as will be appreciated, where the system uses a broadcast methodology to deliver data, delivery to additional recipient devices in parallel will occur in the same manner. FIG. 4 is a block diagram illustrating components of an exemplary system in accordance with an embodiment directed towards media content as an exemplary form a data. As mentioned, the description hereinafter with minor modifications is equally applicable to other forms of data.

The diagram is shown with functional components or sub-systems illustrated, e.g. the recipient device 102, the data deliverer 104, and also with logical functional layers illustrated. In the exemplary embodiment FIG. 4, the data deliverer 104 is illustrated to include a content manager subsystem 410 and an in-cloud controller 418. In other embodiments, the data deliverer 104 may exclude some of these components (such as excluding the content manager subsystem 410), or include additional components (such as including an application server 414 and/or content delivery network (CDN) 422) illustrated in FIG. 4. The functional layers span multiple sub-systems and include various components which interact with each other to deliver certain functionality. In this example there is illustrated the following functional layers:
A content delivery layer 402, which performs the function of physically receiving media content from a content origin (e.g. production house, movie distribution entity or the like), staging it for delivery, and physically transmitting the media content to the recipient device 102.
A control layer, 404, which determines which media content to deliver, and controls the scheduling of the content, and configures and controls the user device 102 to be ready or otherwise prepared to receive the broadcast data.
An application layer 406, which may reside outside the content delivery system, and encompasses applications on which media content may be consumed on the user device as well as mechanisms for operating those applications (e.g. application servers).
An analytics layer 408 is also illustrated. This is optional, and may reside as a sub-system of the data deliverer 104, or an external system. This layer serves to analyse use of the media usage, for various commercial purposes.

The functions of each layer, and component therein will become more apparent as process for pre-positioning media content on a recipient device 102 is described in connection with FIG. 5. In FIG. 5, a series of brackets with reference numerals are marked to illustrate the mapping between the detailed sub-steps set out in the present process flowchart of FIG. 5 and the higher level process steps set out in FIGS. 2 and 3. Common reference numerals are used to indicate the mapping. Similarly which functional blocks of the system illustrated in FIG. 4 performs each substep is indicated by the reference numerals along the top of the flow chart.

As a starting condition to the process 500 illustrated in FIG. 5, one or more media content items to be pre-positioned on a recipient device 102 are selected by the content manager subsystem 410. This media content will reside with a content origin 412, which will typically be a server or data store associated with a content producer. The content manager subsystem 410 will also determine which of the plurality of user devices 102 are to receive the selected media content to be propositioned. The selection of media may be based on the output of the analytics layer 408, or an application server 414 associated with a particular application 416 residing on the user device 102. For example, a sporting league may provide fans with an application on which they can watch highlights of the week's games. In this case the application server 414 associated with that application may determine that a media content item comprising a highlights package of the past weeks games should be pre-positioned on all recipient devices that have their application. Alternatively it may select a different highlights package based on geographic location, which only includes highlights of local teams.

Thus the method 500 begins at 502 with certain media content that is to be pre-positioned on a user device 102. Next at 504, the media content deliverer 104 determines an approximate broadcast timeslot for the content. Continuing the example of sports highlights, this may be 2 am on Tuesday morning, after completion of the last games for the weekend, in a timeslot that has historically communications network demand. This approximate schedule is transmitted at 506 to the in-cloud controller 418, which coordinates and communicates with each of the necessary system and communications network components necessary to pre-position the media content. The in-cloud controller 418 is provided with an identifier for the media content, a desired delivery time, and network channel data on which the media content will be delivered. The in-cloud controller 418 then at 508 determines the resources necessary for delivery, and at 510 interfaces with the content delivery network configuration service 420 of the content delivery network (CDN) 422 to send instructions via an application program interface (API) to schedule the broadcast (e.g. via LTE-B) of the media content and set the corresponding service parameters that the content CDN 422 will use for delivery of the media content according to the schedule.

The CDN configuration service 420 causes at 512 the CDN 422 to ingest the media content for pre-positioning from the content origin 412 to enable delivery. The CDN configuration service 420 also at 514 configures the LTE-B broadcast system 415 for delivery at the scheduled time.

The final configuration parameters of all systems are then transmitted back to the in-cloud controller 418 at 516.

As noted above, in the event that a particular device fails to receive the broadcast of the media content and pre-positioning on that device fails, the system then falls back to delivering the media content via a unicast service. At 518 the in-cloud controller 418 also determines or fetches the configuration data for the fallback unicast service.

Broadcast and unicast configuration parameters are then sent 520 to the (or each) recipient device to enable it to receive the broadcast of the media content. This configuration data is received by the on-device pre-positioning component 424, comprising one more software components running on the recipient device 102. On-device pre-positioning component 424 is configured to perform various functions on the user device 424, including, as noted above:
Controlling the operation of the recipient device 102 to enable it to operate in accordance with the schedule;
Operating as a pre-positioning server to manage playback of pre-positioned media content when a user chooses to consume the media content;
Managing storage (caching of the media content); and, if it is implemented
Logging media and application usage for participating in the analytics functionality.

In some embodiments, the in-cloud controller 418 is configured to recognise, via a registration process and based on information stored in a registration database, each device or the pre-positioning component 424 on each device. For example, the in-cloud controller 418 may be configured to not communicate with a particular device's pre-positioning component 424 if the device or its pre-positioning component 424 is not recongisable. Alternatively or additionally, each device or the pre-positioning component 424 on each device may be configured to recognise, via the registration process and based on information stored in the registration database, the in-cloud controller 418. For example, the in-cloud controller 418 may be configured to not communicate the pre-positioning component 424 may be configured to reject receipt of the broadcast and unicast configuration parameters if the in-cloud controller 418 is not recongisable.

Next, at 522, at the scheduled broadcast time the recipient device 102 enters a phase for receiving the media content. This phase begins at 524 by the user device 102 waking up (if it is in a low power mode) and/or activating any service or background task on the device required for the broadcast (e.g. the pre-positioning service) (if it is in an idle state). Its communications resources are set to receive the broadcast on the designated channel, and the broadcast media content is received at 526. In this example the delivery is via a LTE-B service running on a cellular communications network. However other delivery networks could be used. For example, the in-cloud controller 418 may determine that the delivery method is LTE-B if the number of recipient devices is above a certain threshold (e.g. where the broadcast is unlikely to reach only few recipient devices), and/or if the current traffic is below a certain bandwidth utilisation (e.g. where the network conditions are suited to broadcast). Otherwise, the in-cloud controller 418 may determine that the delivery method is unicast. In any case, where there is no LTE-B availability, the one or more recipient devices may determine that the delivery method is unicast. Where unicast is unavailable (e.g. no LTE cellular coverage), the one or more recipient devices may determine that the delivery method is via another available connectivity means, such as WiFi communication, or 3G or 4G cellular communication, where the user's preferred connectivity will be chosen depending on availability.

Correct receipt of the media content is verified at 528 and the media content is stored at 530. If the media content was successfully received and stored the media content is pre-positioned for deferred consumption by the user on the user device 102, and the application 416 is notified of the pre-positioning at 532.

In the event that reception fails, the user device 102 will at 534 implement a fallback mechanism for receiving the media content. In this case the fallback mechanism uses a scheduled unicast process to retrieve the media content. This process involves the user device waking up 536 (if it is in a low power mode) and/or activating any service or background task on the device required for the unicast (if it is in an idle state) according to the unicast schedule. In this example, unicast delivery involves the recipient device 102 sending at 538 a request to the content delivery network 422 to transmit the media content. This transmission occurs at 540 via conventional unicast methods. As will be appreciated the unicast process is still performed according to the schedule set by the in-cloud controller 418, and thus can be scheduled at a time when network resources are relatively lightly utilised. The delivered media content is then stored at 542. Again if the media content was successfully received and stored, the media content is pre-positioned for deferred consumption by the user on the recipient device 102, and the application 416 is notified of the pre-positioning at 532.

FIG. 5 also illustrates a process for consumption implemented by the user device in some embodiments at 550. The process begins at 552 by the selection of media to be played on the media playback application 416 residing on the recipient device 102. The application 416 makes a call (according to an appropriate protocol) to receive media content for real-time consumption. Instead of this call being received by the CDN directly it is received at 552 by the pre-positioning service of the on-device pre-positioning component 424. The proxy service of the on-device pre-positioning component 424 checks its cache component for pre-positioned media content corresponding to the requested media content and, if it is present, reads (at 524) the stored media content from its data storage and the application plays it back, as normal. In the event on-device pre-positioning component 424 has not pre-positioned the media content, the request is passed to the CDN and delivery of the media content operates as per conventional manner from the CDN.

It will be understood that the invention disclosed and defined in this specification extends to all alternative combinations of two or more of the individual features mentioned or evident from the text or drawings. All of these different combinations constitute various alternative aspects of the invention.

1. A method of data delivery via a communications network, the method including the steps of:
(a) determining a schedule of data delivery;
(b) scheduling in accordance with the schedule one or more recipient devices to pre-position data to facilitate deferred consumption on the respective one or more recipient devices; and
(c) delivering in accordance with the schedule via the communications network the data to the one or more recipient devices to be pre-positioned to facilitate deferred consumption on the respective one or more recipient devices.

2. The method of claim 1 wherein the delivering includes broadcasting the data to the one or more recipient devices.

3. The method of claim 2 further including:
(i) causing the one or more recipient devices to determine whether the pre-positioned data is received by the one or more recipient devices; and
(ii) in the event of a determination of non-receipt of the pre-positioned content by a respective recipient device, causing the respective recipient device to obtain the data via unicast.

4. The method of claim 3 wherein the determination of non-receipt is based on expiry of a predetermined period.

5. The method of claim 3 wherein the broadcasting including broadcasting via Long Term Evolution Broadcast (LTE-B).

6. The method of claim 1 wherein the determining includes determining the schedule based on traffic conditions of the communications network.

7. The method of claim 1 wherein the determining includes determining the schedule based on a geographical location of the one or more recipient devices.

8. The method of claim 1 further including determining the data to obtain.

9. The method of claim 1 wherein the scheduling includes:
communicating the schedule of data delivery to the one or more recipient devices via a pre-positioning service on the respective one or more recipient devices, the pre-positioning service preparing the respective one or more recipient devices to receive and store the data in accordance with the schedule.

10. The method of claim 1 wherein the pre-positioning service is configured to receive and store the data for a plurality of applications on the respective one or more recipient devices.

11. The method of claim 1 wherein the pre-positioned data represents a first part of a data file, and wherein the method further including delivering a second part of the data file to the one or more recipient devices for immediate consumption on the respective one or more recipient devices.

12. The method of claim 1 wherein the one or more recipient devices include two or more recipient devices.

13. The method of claim 8 further including obtaining the determined data to be pre-positioned from a data provider.

14. (canceled)

15. A method of data consumption via a communications network, the method including the steps of, at one or more recipient devices:
(a) receiving a schedule of data delivery determined by a data deliverer;
(b) preparing the one or more recipient devices to pre-position data, to facilitate deferred consumption, in accordance with the schedule;
(c) receiving from the data deliverer via the communications network data delivered in accordance with the schedule; and
(d) pre-positioning the received data on the respective one or more recipient devices to facilitate deferred consumption on the respective one or more recipient devices.

16. The method of claim 15 further including consuming the pre-positioned data on the respective one or more recipient devices.

17. The method of claim 15 wherein the pre-positioned data represents a first part of a data file, and wherein the method further including receiving a second part of the data file to the one or more recipient devices for immediate or substantially immediate consumption on the respective one or more recipient devices.

18. The method of claim 15 wherein the receiving includes listening to a broadcast of the data to the devices.

19. The method of claim 15 wherein the preparing includes waking up the devices and/or activating a service or background task of the devices in accordance with the schedule.

20. The method of claim 15 further including:
(i) determining whether the pre-positioned data is received by a respective recipient device; and
(ii) in accordance with the determination of non-receipt of the pre-positioned content by the respective recipient device, obtaining the data via unicast.

21. The method of claim 20 wherein the determination of non-receipt is based on expiry of a predetermined period.

22. (canceled)

23. A recipient device configured to perform the method of claim 15.

24. The recipient device of claim 23 wherein the method is performed by a pre-positioning service running on said recipient device.

25. A machine-readable medium for facilitating data delivery via a communications network from a data deliverer to a recipient device, the machine-readable medium including instructions for:
(a) communicating with one or more applications of the device configured to consume network data;
(b) communicating with the communications network for pre-positioning data for deferred consumption by the respective one or more applications;
(c) receiving pre-positioned data to facilitate deferred consumption by the respective one or more applications; and
(d) providing the pre-positioned data to the one or more applications for the deferred consumption.

26. A system for data delivery via a communications network, the system including:
(a) one or more recipient devices for receiving content;
(b) a data deliverer communicatively coupled to the one or more recipient devices via the communications network and configured to:
(i) determine a schedule of data delivery;
(ii) schedule one or more recipient devices to pre-position data to facilitate deferred consumption in accordance with the schedule;
(iii) deliver the data to the one or more recipient devices to be pre-positioned, to facilitate deferred consumption in the respective one or more recipient devices, in accordance with the schedule.

27. A method of consuming data on a recipient device that is connected to a communications network, wherein said consumption of data is performed via an application resident on said device, said method including:
providing a pre-positioning service for installation on the device, the pre-positioning service operatively coupled to the application,
the pre-positioning service:
receiving a network request from the application for the delivery of data from a media source connected to the communications network;
determining if the network request relates to data that is pre-positioned in local cache associated with the pre-positioning service; and
in the event that the requested data is pre-positioned in the local cache, providing at least a portion of the data from the local cache instead of the media source.
